(19) United States
(12) Patent Application Publication
(10) Pub. No.: US 2003/0228843 A1
(43) Pub. Date: Dec. 11, 2003

(54) Cellular phone that exposes the user's brain to much less microwave radiation than ordinary cellular phones with the help of a proxy (intermediary) device

(76) Inventor: Yaron Mayer, Jerusalem (IL)

Correspondence Address: YARON MAYER, 21 AHAD HA'AM ST., JERUSALEM, 92151, IL

(21) Appl. No.: 10/388,224

(22) Filed: Mar. 14, 2003

Related U.S. Application Data
(63) Continuation-in-part of application No. 10/318,420, filed on Dec. 10, 2002.
Application No. 10/318,420 is a continuation-in-part of application No. 10/270,793, filed on Oct. 9, 2002.
Application No. 10/318,420 is a continuation-in-part of application No. PCT/IL01/00981, filed on Oct. 24, 2001.
(63) Continuation-in-part of application No. 10/270,793, filed on Oct. 9, 2002.
Application No. 10/270,793 is a continuation-in-part of application No. PCT/IL01/00330, filed on Apr. 9, 2001.
(60) Provisional application No. 60/266,732, filed on Feb. 5, 2001.

(30) Foreign Application Priority Data
Oct. 24, 2000 (IL) 139234
Apr. 9, 2000 (IL) 135556

(51) Int. Cl. H04B 7/00

(52) U.S. Cl. 455/41.2; 455/90.1; 455/90.3; 455/575.7

(57) ABSTRACT

Cellular phones are becoming more common and popular amongst all sectors of the population for business and private conversations, including many children, with about a Billion users worldwide, and about 300,000 new joiners each day. There is much concern and there is already some accumulating evidence that the Microwave emission transmitted by the cellular antenna that is held close to user's head may have deleterious effects on the user, such as for example brain or eye cancer, and possibly even more so for children. One of the most common ways to try to avoid these problems has been the usage of personal earphones with microphone, but on Apr. 4, 2000 it was published worldwide that a research conducted by the “Which?” consumer Magazine in Britain found that in fact the earphone and its cable can act as an Antenna and also expose the user to the microwave radiation. The present invention solves the above problem in using earphones with cellular phones by a reverse and more sophisticated solution than short range wireless earphones, and also solves the problem that many people don't like using headsets at all.

### BACKGROUND OF THE INVENTION

1. Field of the Invention

The present invention relates to cellular phones, and more specifically to a system and method for exposing the user's brain to much less microwave radiation than ordinary cellular phones with the help of a proxy device.

2. Background

Mobile or cellular telephones are becoming more common and popular amongst all sectors of the population for business and private conversations, including many children. There are hundreds of millions of users around the world already, and more than 300,000 new users are joining each day. For example in Britain, cellular phones have become the most popular gift for children and there are now more than 500,000 children in Britain alone who are using cellular phones. There is much concern that the microwave emissions from the cellular antenna that is held close to user's head may have deleterious effects on the user, such as for example tumors, Altzheimer, and other medical and psychological problems. For example, just on October 1999, Dr. George Carlo, head of the Cellular Research Institute in Washington came up with frightening results: He found that the usage of cellular phones increases the chance for brain tumors and also may cause genetic damage. Altogether, since 1997, more and more research has increased the suspicions that the electromagnetic emissions of cellular phones to the brain are dangerous. Already in December 1996 an article published in LA Times showed suspicions that it might cause also Altzheimer disease. In Scandinavia in recent years there have been even more warnings about these possible dangers. Also, many people are complaining about headaches after using cellular phones. Recent studies, such as described in an article by Allan Frey in Environmental Health Perspectives of March 1988, and in Dr. George Carlo's book, Cell Phones: Invisible hazards in the wireless age, published in 2001, have shown that even short time exposure to microwave radiation at the level and frequencies typical of cellular phone quickly causes a breakdown of the Blood-Brain-Barrier, which protects the brain from carcinogens and other toxins in the blood stream, and this is suspect of being the main mechanism that might cause both cancer and the headaches.

Many have searched for methods for protecting the cellular phone users from this radiation. One of the most common ways to try to avoid these problems until recently has been the usage of headsets—personal earphones with microphone. On Apr. 4, 2000 it was published worldwide that a research conducted by the “Which?” consumer Magazine in Britain found that unfortunately instead of protecting the users of cellular phones from the electromagnetic radiation (and especially the microwave radiation), in fact the earphone and its cable can act as an Antenna and expose the user to up to even 3 times more dangerous radiation than when using the cellular phone directly without the external earphone. Furthermore, this emission goes directly to the brain. This finding is extremely shocking and intolerable since so many people have been buying these earphones because of publications that they prevent or reduce the exposure to the radiation of the cellular phones. In addition to this, the report of the independent expert committee on cellular phones hired by the British government, published on May 11, 2000, estimated that children are even more vulnerable to the effects of the cellular phone radiation than adults.

In addition to this, according to an article in the Israeli newspaper Maariv from Aug. 4, 2000, a medical doctor from Baltimore just sued a number of cellular companies for 800 million dollars, claiming that it caused him brain tumor. He also appeared on TV and called to the public to stop using cellular phones and not to give them to children. Also, according to the Baltimore Sun of Jan. 17, 2001, Peter Angelos recently joined the $800 million lawsuit by the Baltimore neurologist, and plans to file additional class-suits against members of the US mobile phone industry. These latest developments will probably also cause the cellular companies to be much more willing to adopt safer solutions.

One possible solution is using a special headset (with at least 1 earphone and microphone) where the cable is based on non-metallic conductors, such as for example sound conductors (e.g. a hollow air tube) or optic fiber(s), as described in a separate patent application by the present inventor.

Another possible solution, offered recently by Erikson and a few additional companies, is to use a headset based on bluetooth technology. Bluetooth technology can broadcast only to a small distance (typically up to about 10 meters), and therefore, although it also uses microwave radiation, its levels are much lower than cellular phones—between 1-10 milliwatts, compared to up to 2 watts in cellular phones, so the levels of radiation should be 100-1000 times lower. An additional advantage is that the cellular phone itself can be even in your suitcase or bag while answering calls through the headset. On the other hand, if you want to initiate a call in this way while the phone is not in your hands (especially when it is in your bag or suitcase), you need to use voice commands for dialing, which is what Erikson offers, eventhough probably cheaper versions will be available without this additional option. Bluetooth technology also has a built-in automatic encryption and decryption and a built-in ability to automatically jump between many channels of different frequency (typically at least 80 channels) in order to avoid conflict and interference with other nearby bluetooth devices. This is supposed to be the new state of the art for cellular headsets in about 2 years from now.

### SUMMARY OF THE INVENTION

The present invention is a reverse and a more sophisticated solution that complements the above described bluetooth headset solution. Since many people don't like using headsets at all because they feel they are less convenient and because many cheap headsets use earphones and microphones of poor hearing quality (compared to the level of the built-in microphone and speaker in the phone itself), the present solution solves the problem also for all those people that prefer to use the phone directly without the earphones.

More specifically, the level of microwave radiation to which the user is exposed near his brain is reduced by a large factor by enabling the phone to communicate with a very near proxy device by using low levels of radiation to communicate wirelessly with the proxy device or using an alternative method with no metallic wire and no radiation to communicate with the proxy device. This can be done in a number of preferable ways:

1. The cellular phone is redesigned so that instead of using an ordinary cellular phone antenna it can use preferably a bluetooth chip or any other device for short range low energy wireless communication, and instead of communicating with the cellular company's nearest cell or cells (as a normal cellular phone would do), it can communicate with a proxy device, which is a transducer that on one hand transfers information from and to the cellular phone through another bluetooth chip or similar device, and on the other hand communicates preferably through a normal cellular antenna with the cellular company's nearest cell(s) instead of the cellular phone. Also, preferably, the recharger unit of the cellular phone is redesigned so that it has two sockets, one for the cellular phone and one for the proxy, and so both can be recharged at the same time, or for example the cellular phone or the proxy can have a separate recharge socket of their own, so that the two devices can be connected to the recharger in serial mode instead of in parallel. Another possible variation is that preferably the phone has also its normal antenna and its related circuits, and preferably is able to sense if there is any temporary problem with the proxy device and if for some reason the proxy device cannot be reached or does not function, the phone can then preferably temporarily revert to normal operation and communicate with the cellular company's nearest cells normally. In such a case, preferably a sound and/or light will flash, alerting the user that he is again exposed to the microwave radiation. Preferably, in this case, the warning sound will keep repeating every few seconds, thus reminding the user all the time that he is currently using the phone in potentially unsafe mode. Preferably, the cellular phone and the proxy set both have a matching private encryption key, and will refuse to communicate with a pair that does not fit. Preferably, this private encryption key can be easily added or changed, for example by use of EPROM, in each of the two members of the pair (the phone or the proxy) for example in case the other member (the phone or the proxy) was lost or damaged. The use of the proxy will be OK also when the cellular phone is used for data communication (instead of voice communication), such as for example Internet access, because the bluetooth and similar technologies can transfer at least 1 Megabit per second and will probably improve further in the future, and especially for example UWB can offer even much faster transfer rates (in UWB the encryption and/or avoidance of collisions with other phone-proxy pairs can be based for example, in addition or instead, on the temporal scattering of the pulses and/or their width and/or their frequencies, and/or their shapes and/or any other characteristics of the pulses.) Another possible variation is that when using the cellular phone for data communication, since the phone is typically in the user's hand and away from his head, the user might be given the choice also on purpose to work without the proxy and temporarily disable the warning. However, this is not recommended, since for viewing the cellular phone's screen the cellular phone might still be held relatively close to the user's head or for example to his chest. Another possible variation of this solution is that the phone does not have a normal cellular antenna and its circuitry and always relies on the proxy to communicate with the cellular company's cells, and preferably is based on maximum energy saving and therefore preferably also has a smaller rechargeable battery and/or can work longer before recharging is needed, so that it is preferably considerably lighter than a normal cellular phone. This can be accomplished for example by using CMOS circuits as much as possible and PWM (Pulse width Modulation) and also for example a Piezoelectric speaker or for example a speaker based on a small air-tube that goes into the ear like in hearing aids for the deaf, which saves energy, etc. (However, such an invasive device would be of course less desirable). If PWM is used, it can be used for example while communicating between the phone and the proxy, or the communication can be any other communication such as for example the standard Bluetooth protocol, and in that case the PWM can be used for example inside the phone itself to transfer the information in an energy-efficient manner to the speaker. An additional preferable way of saving energy is for example to automatically reduce the duty cycle of the transmitter (or stop it completely) when the user is not talking, and when he starts to talk it is quickly restarted. This might cause a few milliseconds of speech at the start of a new speech to become lost, but that is negligible. In some embodiments these energy-efficiency principles can be used also with the other solutions and especially for example solution number 2, so that when the phone is held near the user's head and communicates with the proxy it works in the energy efficient mode, and for example when the proxy is used as headset it also consumes as little energy as possible, thus preferably extending time until recharge is needed. If such methods of energy saving are applied for example to bluetooth or other short range low energy wireless headsets, then the battery can be either a single-use battery, preferably one that can last a long period such as for example a few months (for example with up to 3 hours talk-time per day) with the efficient circuit, or a rechargeable battery that preferably can also last relatively longer with the efficient circuit until recharge is needed. This is considerably better than the state of the art of having to recharge after at most a few hours of talk. However, since for example in current day bluetooth chips typically most of the energy is used by the RISC processor, it might be difficult to considerably save energy this way, whereas other methods such as for example UWB or other pulse based carrier-free technologies can be much more energy efficient. Preferably, the phone can also fold open into a shape of a headset or have part of it extended and be conveniently hung on the ear or on the head, preferably with an appropriate band or hook, and so the phone itself can function dually both as a hand-held phone and as a hands-free headset device, which is also very useful for example when driving, so that the driver does not need to dial first with the phone and then look for the headset and insert it, as is typically done in the present state of the art normal type of earphones. Preferably, the phone is made even lighter by making it for example thinner, and possibly also somewhat smaller. This variation has the advantage (compared to solution number 2) that only one (preferably high quality) speaker and earphone are needed in the system and only one cellular antenna and it's circuitry and it's required battery are needed in the system (Typically in cellular phones most of the energy is needed for communicating with cell, so this is why the battery of the phone in this configuration can be lighter than the battery of the proxy). However, preferably the phone has a lighter battery (compared for example to an equivalent normal cellular phone) even in the variation where it has also the normal cellular antenna, since obviously it has to use this antenna only in emergencies or other rare occasions that make it impossible to connect to the cells through the proxy. Another possible variation is that preferably in both versions—with or without the cellular antenna—the phone can preferably have an even lighter battery and is preferably able to be recharged automatically when connected to the proxy even without the normal recharger, since in that case the battery can be automatically recharged more often. This can be especially useful in the two-part phone variation described below, since in that variation the phone and proxy are preferably together all the time except when the user answers or initiates a call. If the phone is used also for Internet access, then one possible variation is that the proxy itself has also a display screen, which is preferably bigger than the phone's display screen, and preferably also a convenient keyboard, so that the user can either hold the phone in his hand for Internet access, or use it as headset and hold the proxy in the hand for viewing the screen and keying commands. However, as explained above, such a usage is less recommended since the user might hold the device still too close to his head or for example to his chest, so the variation of using only the phone for internet access with or without a headset, and a separate proxy, as described below, is more preferable. Another possible variation is that the phone fits over the proxy like a phone cover, like a two-part phone, so when the user opens the phone to initiate or answer a call it feels like picking up the phone's cover. Of course, this two-part phone concept wherein one part is a preferably light phone, preferably without the heavy battery and the cellular antenna and its circuitry, and the other part is the proxy, can be implemented in a many ways, and is intended to cover any variation wherein the two devices behave and/or look like a single device preferably when being recharged and/or when not in use and/or are perceived like a single device with two preferably integral parts, and preferably detouch into two devices whenever the user answers or initiates a call. For example the phone and proxy pair can look together like any ordinary cellular phone, but in order to answer or initiate a call preferably the user has to separate them. In this case preferably the phone is recharged from a recharge socket on the proxy itself, which is most natural in this case and gives the user a feeling of normally recharging the phone, while actually he is recharging both the phone and the proxy. Another possible variation is for example the opposite, so that the proxy is recharged through the phone. This type of two-part phone configuration could be used also for example with normal Bluetooth or UWB headsets or other wireless headsets or for example optic fiber headsets, so that for example when the user picks up the phone's cover he is actually picking up the headset, or at least the headset and the phone are recharged together serially or in parallel. Preferably, in these cases the headset can also be recharged automatically from the phone by being connected to it even without the normal recharger, thus preferably allowing the use of a lighter battery at the headset. Another possible variation is that preferably the proxy contains preferably just the transducer, and preferably only the phone contains the screen and the phone can be used preferably either for talking or for sliding the Internet or both at the same time, and in addition the phone can be used for example with a normal hands-free earphone or with a wireless earphone. If used with a wireless earphone then the phone can for example communicate with both the earphone and the proxy by bluetooth or similar device. Another possible variation is that in this case for example the headset can also communicate directly with proxy instead of or in addition to being able to communicate with the phone. Anyway, it is clear from the above variations that the combination of the phone and proxy together can typically be accomplished preferably without substantially or significantly increasing the weight and size together compared to an ordinary cellular phone, so that the fact that the phone is working with the proxy does not mean that the user has to carry altogether a substantially larger weight or volume than with a normal cellular phone. In fact it can be even less weight than when holding a normal cellular phone, if the user holds near his head just the phone, which, as explained above, can be made lighter than a normal cellular phone, and the proxy is for example in a bag or lying somewhere near the user. The proxy is preferably a dedicated device who's main or only function is reducing the radiation as explained above. This is in contrast to U.S. Pat. Nos. 5,533,097 issued on Jul. 2, 1996 to Crane et. al., and 5,983,073, issued on Nov. 9, 1999 to Ditzik, which were brought up in the International search report. In the Crane patent a handset is used that communicates with a briefcase that can communicate with wide area networks in multiple formats, and the reduction of radiation issue is not brought up at all. The Ditzik patent mentions a handset or headset that can communicate with lower energy with a notebook computer which has access to a wide area communications system. However in both of these patents the user obviously has to carry a device that can be considerably larger or heavier than a cellular phone, which is quite impractical for someone who wants to carry just a cellular phone. Another problem with the Ditzik patent is that if the user for example uses the notebook computer for example close to his head or his chest he can still be exposed to the radiation, whereas according to the present invention any such computer would still preferably communicate with a separate preferably dedicated proxy device that can preferably be at a distance from the user. Another possible variation is to add to the cellular phone and/or to the proxy for example volume control and/or pitch control, which are currently unavailable in cellular phones and in cellular earphones, in order to improve further the sound quality for example when it is difficult to hear. This can be used for example in solution 1 or in solution 2, and also for example with any cellular phone or headset independently of any other features of this invention. Another possible variation which can be used with this and/or with any of the other solutions is that the phone and/or the proxy can be used to signal to the other device to emit a sound so that the user can find it if he misplaced it and has in his hand just one of the two devices. This feature can be used also independently of any other feature of this invention and also used for example with normal wireless or bluetooth or similar device headsets. Of course, various combinations of the above and additional variations can also be used.

2. Same as solution 1, except that the phone has also the cellular antenna and its related circuits and the proxy device is preferably shaped like a headset (preferably at least in one of its states, such as for example when unfolded) and has also a preferably high-level microphone and earphone and can also function dually—in this case as either a proxy device, or as a headset. In this solution the proxy is preferably even more light in weight. When the user opens the phone and uses it normally, the proxy device preferably functions as described in solution number 1 (At least regarding some of the variations described in solution 1). On the other hand, if the user wants to put away the cellular phone and use a headset, he can use the proxy device as a headset and then the proxy device preferably disables its cellular antenna and the communication with the cellular company's cells and activate its speaker and earphone, and the cellular phone preferably deactivates it's own speaker and earphone and reactivate it's normal cellular antenna and related circuitry and communicates with the cellular company's nearest cells. By this sophisticated way the user can always have very low radiation levels both if he uses the phone directly and if he uses the proxy as headset. Another possible variation is that preferably, since the proxy device has already also the normal antenna and its related circuits, it also is able to sense if there is any temporary problem with the cellular phone, and if for some reason the cellular phone cannot be reached or does not function, the headset can then temporarily communicate directly with the cellular company's nearest cells. In such a case, preferably it will for example indicates a sound from its earphone, alerting the user that he is again exposed to the microwave radiation, and preferably keep repeating this sound every few seconds, reminding the user all the time that he is currently using the headset in potentially unsafe mode. In this solution, preferably both the proxy and the cellular phone can also talk to other bluetooth or similar devices in the home or in the office, so for example they can automatically (or for example by changing a switch or pressing some key(s)) communicate with the computer or with the regular phone base, when they also have a bluetooth chip or similar device. Since the rechargeable batteries required for the communication with the cellular company's cells might make the proxy device heavier, which makes it less convenient to use as an earphone, preferably the proxy uses lighter batteries, such as for example the new patented Hydrogen based batteries from Nec, which also have a much faster recharge time than ordinary batteries, and also preferably uses more energy efficient speaker and earphone. Another possible variation is that the proxy is composed of two easily detouchable parts, so that preferably one part contains the heavier battery needed for cellular communications and the cellular antenna and its circuitry, and the other part contains at least the earphone and microphone and a lighter battery, and preferably when the parts are physically coupled they are electrically connected, and when the user wants to use the proxy as headset he can remove and use just the needed part. Another possible variation is that phone and/or the proxy have a lighter battery than a usual cellular phone and preferably can automatically exchange energy between them when connected to each other even without the normal recharger, thus preferably sharing the energy on a need basis—for example if one of them has been used for a longer time for communicating with the cell. Of course, various combinations of the above and additional variations can also be used.

3. The cellular phone itself does not have to be changed and the two bluetooth chips or similar devices are not necessary, and instead the proxy is capitalizing on the cellular phone's ability to lower its radiation level automatically depending on the distance to the nearest cell. In this solution the proxy preferably imitates the cell by making the phone believe that it is talking to a very close cell, and on the other hand it communicates with the cellular company's cell, as in solution 1. The ability to implement solution number 3 might depend on the cellular communication protocol with the cell and on the extent and range by which the cellular phone is able to lower its radiation levels for very close cells. This solution can be useful for dealing for example with some currently existing cellular phones. However, cellular phones can be optimized to take more advantage of this, so that if for example a normal cellular phone might not go below a certain energy level in any case (because with normal cells for example a certain minimal distance might be assumed), a cellular phone can be designed so that it can reduce the energy level of the normal antenna to the very low levels needed to communicate for example with a proxy device that is just a few meters or less away. Preferably for example when a few users are close to each other the proxies and/or the phones (for example if the phone is redesigned for this) can use preferably automatic frequency hoping and/or encryption like in Bluetooth, in order to help privacy and/or avoid disturbances between the devices. Also, if the phone is redesigned, preferably it is also able to indicate to the user for example by a flashing sound or light if the proxy device cannot be reached or is malfunctioning, so that the user knows that he might now be exposed to the normal cellular radiation.

4. Solution number 4 is similar to solution number 1, except that the proxy device is preferably physically coupled to the cellular phone at any convenient position or angle and extends the position of the cellular antenna away from the user's head as far as conveniently possible, preferably on a non-metallic rod, such as for example plastic. Preferably, this angle can be changed by the user in various directions, preferably by using a ball-type hinge. So, for example, the proxy can position the cellular antenna upwards away from the head, or downwards, at the opposite direction than usual, as far from the brain as conveniently possible. Preferably, this rod can be easily made longer or shorter by the user (preferably by telescopic design, or for example by being divided into several parts with one or more hinges between each two parts, so that it can be folded and unfolded in various ways). However, in this solution the cellular antenna's distance from the brain might be smaller than in the other solutions, so the reduction of the level of radiation that the user's brain is exposed to might be smaller than in the other solutions. Preferably, the proxy can be also easily removed from its position on the phone and can also be used further away from the user's head, as in solution 1. Preferably, for recharging, the proxy can either be removed from its position on the phone and moved to the appropriate socket, or for example an auxiliary wire can be used that is removed when not recharging.

5. Solution number 5 is the same as solution number 1, except that instead of the bluetooth or other short range wireless device it uses optic fiber or fibers for the communication between the cellular phone and the proxy device. Preferably, the optic fiber can be easily and modularly replaced if damaged. One of the possible variations in this case and/or for example with solution no. 6 is to use for example in any of the connected devices a passive reflective microphone that works for example by a membrane that reflects a light beam back through one or more optic fibers, in order to save energy.

6. Solution number 6 is the same as solution number 2, except that instead of the bluetooth or other short range wireless device it uses optic fiber or fibers for the communication between the cellular phone and the proxy device. Preferably, the optic fiber is detouchable and can be easily replaced if damaged.

7. Solution number 7 is the similar to solution number 4, except that instead of the bluetooth or other short range wireless device it uses optic fiber or fibers for the communication between the cellular phone and the proxy device. Preferably, the optic fiber can be folded or released (for example around part of the proxy, or around a small wheel which is attached either to the phone or to the proxy, preferably with a spring), so that the proxy can also be used further away from the user's head, as in solution 4. Preferably, the optic fiber can be easily replaced if damaged.

If for example infrared or other light wavelength is used for the short range communication instead of electromagnetic communications, in any of the variations without optic fibers, there are a number of possible ways for enabling automatic frequency hoping in order to avoid interference between users who are close to each other, or in other words, improve privacy and avoid cross-talk with devices of nearby users. This can be done for example by encrypting the communication between the phone and the proxy, preferably in a different way for each pair. One preferable way of accomplishing the preferably automatic frequency selection for example with visible light or infrared is for example to use LED arrays or matrices (for example in a chip) with a preferably large number of LEDs of different frequencies each, so that the appropriate LEDs can be easily chosen. Another preferably way of doing this is to use for example a smaller set of LEDs and use various power combinations to create the desired combined frequency, similar to a color pixel on a color LCD screen, preferably with a lens or prism that combines the lights together. Another possible way of accomplishing this is for example to use a set of differently colored filters in front of a LED or LEDs covering a certain range of frequencies so that different filters or combinations of filters can be automatically chosen and moved (for example by rotation) in order to change the frequency. Similarly, the light decoders in these solutions are preferably capable of similarly tuning-in to the chosen frequency, for example by a using a similar matrix of detectors, each responsive to a given frequency, or using a smaller set of detectors and measuring the amplitude in each of them, or using a similar set of changeable filters in front of the detectors. Another possible variation is using for example tunable diodes. Another possible way to avoid collisions with other devices is for example to use, instead of or in addition to frequency hopping, a choice of different broadcast characteristics, such as for example using fatter or thinner bits, or using different bit placement within each frame of communication. Various combinations of these solutions can also be used. These solutions can be used also independently of any other features of this invention and can be used for example also for free-air optical communication between normal headsets and cellular phones.

### BRIEF DESCRIPTION OF THE DRAWINGS

FIG. 1 is a schematic block diagram of a preferable arrangement of the system.

FIG. 2 is a schematic illustration of preferable changes in the cellular phone's design and function in solution number 1.

FIG. 3 is a schematic illustration of a preferable proxy device's design and function in solution number 1.

FIG. 4 is a schematic illustration of preferable changes in the cellular phone's design and function in solution number 2.

FIG. 5 is a schematic illustration of a preferable proxy device's design and function in solution number 2.

FIG. 6 is a schematic illustration of a preferable proxy device's design and function in solution number 3.

FIG. 7 is a schematic block diagram of a preferable variation where the proxy contains just a transducer and the phone can use a separate headset.

FIG. 8 is an illustration of a preferable variation where the proxy device is coupled to the cellular phone and extends the position of the cellular antenna away from the user's head, as for example in solutions 4 & 7.

### Important Clarification and Glossary

Throughout the patent when variations or various solutions are mentioned, it is also possible to use various combinations of these variations or of elements in them, and when combinations are used, it is also possible to use at least some elements in them separately or in other combinations. These variations are preferably in different embodiments. In other words: certain features of the invention, which are described in the context of separate embodiments, may also be provided in combination in a single embodiment. Conversely, various features of the invention, which are described in the context of a single embodiment, may also be provided separately or in any suitable subcombination. All these drawings are just exemplary diagrams. They should not be interpreted as literal positioning or shapes or angles or sizes of the various parts, such as for example the blutooth chip, the antennas, etc. Also, throughout this patent, including its summary and the claims, when the words “on one end” or “on the other end” or “at one end” or “at the other end” or “on one hand” or “on the other hand” are used, they are meant conceptually and not literally—so for example the bluetooth and the cellular antenna on the proxy are not necessarily positioned opposite to each other physically. Also, throughout this patent including its summary and the claims, whenever the word “bluetooth” is used it means either bluetooth or any other device for short range low energy wireless communication at any acceptable frequency (including, for example, also infra-red), and including for example UWB (Ultra Wide Band) or any other type of pulse-based communication. Also, whenever the word “cell” or “cells” is used throughout this patent, including the summary and the claims, it means interchangeably either cell or cells and it means all types of communication cells wherever they are, such as for example cells on the ground, cells in the air, such as for example on balloons, satellites, etc. Also, the term “optic fiber” or “optic fibers” or “fiber optic” as used throughout the text, including the claims, are always meant interchangeably to be either optic fiber or optic fibers. Also, the term “cellular phone” or “mobile phone” or “wireless phone” or “phone” or “telephone” as used throughout the patent, including the claims, can mean any device for communications through wireless and/or cellular technology, including for example Internet-enabled cellular phones, such as for example the Japanese DoCoMo, 3^{rd} Generation cellular communication devices, palm computers communicating by cellular and/or wireless technology, etc. Whenever the words “he” or “his” or “him” is used about the user, it is just for clarity and convenience, and it refers of course also to female users. The various reversals in roles between the phone and the headset or proxy can be described also in terms of transferring various features between them. So for example the phone can be described alternatively as a headset which has been given most or all of the features of a phone until it becomes practically a phone, and vice versa.

### DETAILED DESCRIPTION OF THE PREFERRED EMBODIMENTS

All of the descriptions in this and other sections are intended to be illustrative examples and not limiting.

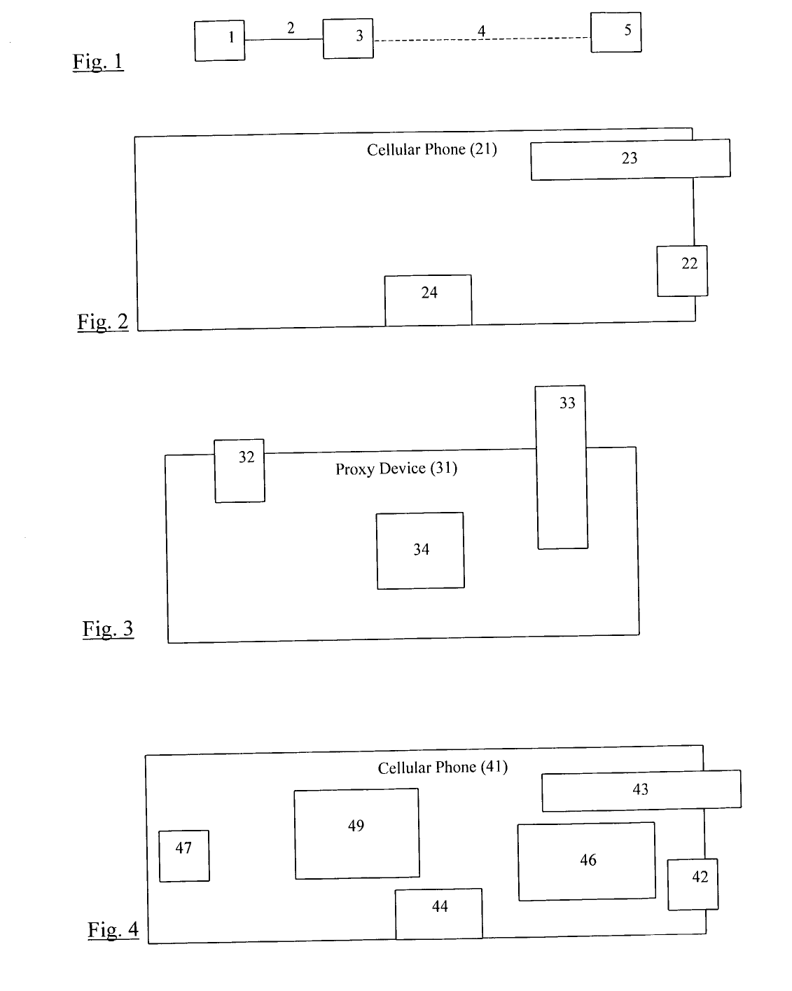

Referring to FIG. 1, the cellular phone (1) communicates (both ways—to and from) through short range low energy wireless communication (2) with the proxy device (3), which communicates on its other end through normal cellphone microwave broadcast (4) (both ways—to and from) with the cellular company's nearest cell or cells (5).

Referring to FIG. 2, the cellular phone (21) contains a bluetooth chip or similar device (22) and uses it to communicate (both ways—to and from) with the proxy device (31 in FIG. 3) instead of communicating normally with the cellular company's nearest cell or cells (5 in FIG. 1). In another possible variation, preferably, it has also still the normal cellular antenna and its related circuitry (23), so that it can communicate normally with the cellular company's nearest cell or cells (5 in FIG. 1) whenever it is unable to reach the proxy (31 in FIG. 3) for any reason. In such a case, preferably it will flash a sound and/or light (24), in order to alert the user that he is again exposed to the microwave radiation, and preferably keep repeating the sound every few seconds to alert the user that he is still in unsafe mode. Preferably, this will be a short high pitch beep from its built-in speaker.

Referring to FIG. 3, the proxy device (31) contains a bluetooth chip or similar device (32) and uses it to communicate (both ways—to and from) with the cellular phone (21 in FIG. 2) on one hand, and on the other hand has a typical cellular phone's antenna and related circuitry (33) for communicating (both ways—to and from) with the cellular company's nearest cell or cells (5 in FIG. 1). Preferably, it uses a CPU or CPUs (34) for its cellular protocol and for converting information (to and from) between the protocols of its two ends.

Referring to FIG. 4, the cellular phone (41) contains a bluetooth chip or similar device (42) and uses it to communicate (both ways—to and from) with the proxy device (51 in FIG. 5) instead of communicating normally with the cellular company's nearest cell or cells (5 in FIG. 1). It has also still the normal cellular antenna and its related circuitry (43), so that it can communicate normally with the cellular company's nearest cell or cells (5 in FIG. 1) whenever it senses that the user is communicating with it through the proxy device (51 in FIG. 5) (acting as headset) instead of directly, and preferably also whenever the user is using the cellular phone directly but the phone is unable to reach the proxy (51 in FIG. 5) for any reason. In the second case, preferably it will flash a sound and/or light (44), in order to alert the user that he is again exposed to the microwave radiation. The cellular phone has the appropriate logic, preferably in its CPU or CPUs (49), to operate in 2 different modes when communicating with the proxy (51 in FIG. 5), so that in mode 1 (when the user is using the phone directly) the phone preferably activates normally its built-in speaker (46) and microphone (47), disables its normal cellular antenna and related circuitry (43), and preferably tells the proxy device (51 in FIG. 5) through a special signal or signals on the bluetooth or similar channel to act as normal proxy. Preferably, the cellular phone can detect that it is being used directly by the user through either the fact that it is open and/or some keys have been pressed or through receiving a signal or signals from the proxy (51 in FIG. 5) (through the bluetooth or similar channel) indicating that the proxy is not currently being used as a headset. In mode 2 (when the user is using the proxy device (51 in FIG. 5) as headset), preferably the cellular phone deactivates its built-in speaker (46) and microphone (47), activates its normal cellular antenna and related circuitry (43), and preferably tells the proxy device (51 in FIG. 5) through a special signal or signals on the bluetooth channel to act as headset. Preferably, the cellular phone can detect that it is not being used directly by the user through either the fact that it is closed and/or no keys have been pressed or through receiving a signal or signals from the proxy (51 in FIG. 5) (through the bluetooth or similar channel) indicating that the proxy is indeed currently being used as a headset. Preferably, the logic will also alert the user though an appropriate message to any situation where the proxy (51 in FIG. 5) and cellular phone are not in compatible modes and/or are unable to agree on the mode for some reason.

Referring to FIG. 5, the proxy device (51) contains a bluetooth chip or similar device (52) and uses it to communicate (both ways—to and from) with the cellular phone (41 in FIG. 4) on one hand, and on the other hand has a typical cellular phone's antenna and related circuitry (53) for communicating (both ways—to and from) with the cellular company's nearest cell or cells (5 in FIG. 1). Preferably, it uses a CPU or CPU's (54) for its cellular protocol and for converting information (to and from) between its two protocols. In addition to this, it also has a preferably high level earphone (55) and microphone (56) and preferably it has the shape of a headset, or for example it folds when used as normal proxy and opens to the shape of a headset when used as headset. The proxy device also has the appropriate logic, preferably in its CPU or CPUs (54), to operate in 2 different modes when communicating with the cellular phone (41 in FIG. 4), so that in mode 1 (when the user is using the phone directly) the proxy preferably deactivates its earphone (55) and microphone (56), activates its normal cellular antenna and related circuitry (53), and preferably tells the cellular phone (41 in FIG. 4) through a special signal or signals on the bluetooth or similar channel that it is currently functioning as normal proxy. Preferably, the proxy device can detect that it is being used as normal proxy through either the fact that it is in closed position and/or some switch has been changed or through receiving a signal or signals from the cellular phone (41 in FIG. 4) (through the bluetooth or similar channel) indicating that the phone is currently being used directly by the user. In mode 2 (when the user is using the proxy device as headset), preferably the proxy activates its earphone (55) and microphone (56), deactivates its normal cellular antenna and related circuitry (53), and preferably tells the cellular phone (41 in FIG. 4) through a special signal or signals on the bluetooth channel that it is currently being used as headset. Preferably, the proxy device can detect that it is currently being used by the user as headset through either the fact that it is open and/or some switch has been changed or through receiving a signal or signals from the cellular phone (41 in FIG. 4) (through the bluetooth channel) indicating that the phone is currently regarding the proxy as a headset. Preferably, the logic will also alert the user though an appropriate message to any situation where the proxy and cellular phone (41 in FIG. 4) are not in compatible modes and/or are unable to agree on the mode for some reason. Preferably, since it has also already the cellular antenna and its related circuitry (53), it can also sense whenever the cellular phone (41 in FIG. 4) is unreachable or does not function for some reason and then it can temporarily communicate directly with the cellular company's nearest cell or cells (5 in FIG. 1). In such a case, preferably it will indicate a sound (preferably a short high pitch beep from its normal earphone), in order to alert the user that he is again exposed to the microwave radiation, and preferably keep repeating this sound every few seconds to alert the user that he is still in unsafe mode. Preferably, this Proxy device has also voice command activation in order to dial automatically when used as headset, however, it might have also a small set of keys that enable the user to dial directly if for some reason the voice activation does not function. The logic for the voice command activation may be either in the proxy or in the cellular phone. Or it might have the set of keys instead of the voice command

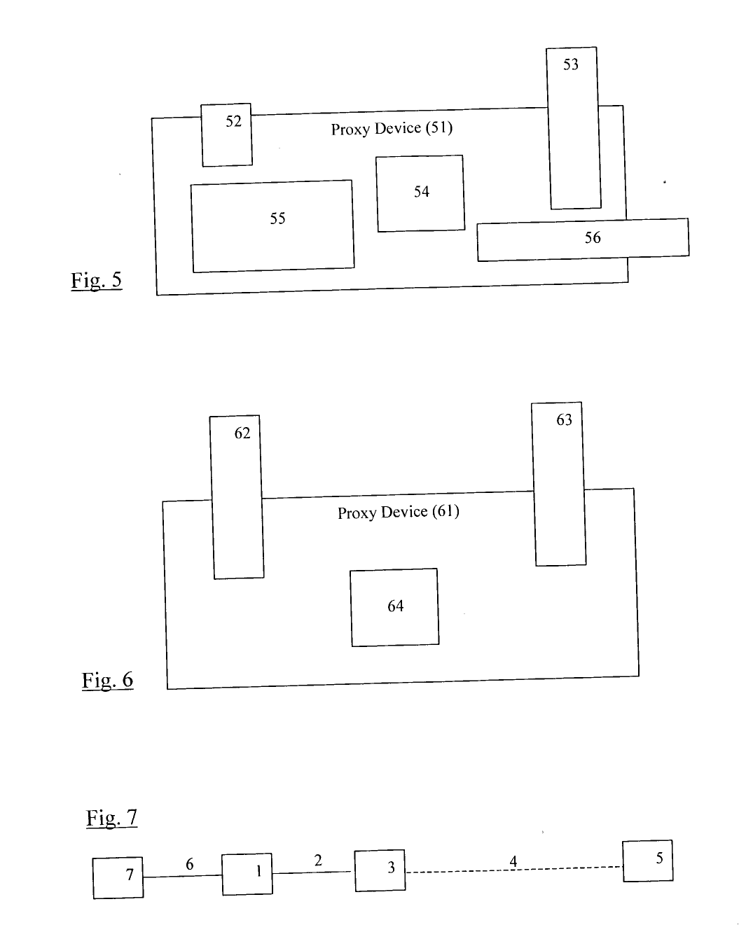

Referring to FIG. 6, the proxy device (61) can have for example two cellular antennas and use one of them (62) to communicate (both ways—to and from) with the cellular phone (1 in FIG. 1) on one hand, and use the second cellular antenna (63 when communicating with the cellular phone and for converting) on the other hand for communicating (both ways—to and from) with the cellular company's nearest cell or cells (5 in FIG. 1). Preferably, it uses a CPU or CPUs (64) for imitating the appropriate cell protocols information (to and from) between its two protocols. Another possible variation is that for making it cheaper, the proxy has just one cellular antenna instead of two. In that case, preferably in different embodiments, it can use for example fast timesharing so that the same antenna can communicate intermittently with the cellular phone (1 in FIG. 1) and with the cellular company's cell or cells (5 in FIG. 1), or use different frequencies to communicate at the same time both with said cellular phone (1 in FIG. 1) and with the cellular company's cells (5 in FIG. 1).

Referring to FIG. 7, the cellular phone (1) communicates (both ways—to and from) through short range low energy wireless communication (2) with the proxy device (3), which communicates on its other end, typically through normal cellphone microwave broadcast (4) (both ways—to and from) with the cellular company's nearest cell or cells (5). In this variation the proxy preferably includes just the transducer, in other words it just translates between the two communication protocols, using a normal cellular antenna on one end and a bluetooth chip or other short range low energy wireless communication device on the other end. The phone (1) preferably contains the short range communication device instead of the cellular antenna, in order to save energy & cost and preferably contains a lighter battery. In addition to this, the phone (1) can also communicate with optional headset (7) for example through short range low energy wireless communication or through normal wire (6).

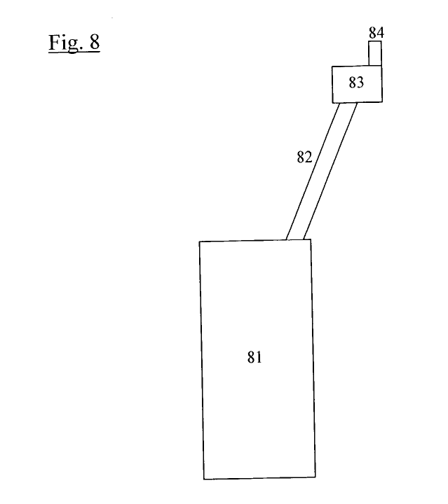

Referring to FIG. 8, the proxy device (83) is preferably physically coupled to the cellular phone (81) at any convenient position or angle and extends the position of the cellular antenna (84) away from the user's head as far as conveniently possible, preferably on a non-metallic rod (82), such as for example plastic. Preferably, this angle can be changed by the user in various directions, preferably by using a ball-type hinge. So, for example, the proxy (83) can position the cellular antenna (84) upwards away from the head, or downwards, at the opposite direction than usual, as far from the brain as conveniently possible. Preferably, this rod (82) can be easily made longer or shorter by the user (preferably by telescopic design, or for example by being divided into several parts with at least one hinge between each two parts, so that it can be folded and unfolded in various ways). However, in this solution the cellular antenna's distance from the brain might be smaller than in the other solutions, so the reduction of the level of radiation that the user's brain is exposed to might be smaller than in the other solutions. Preferably, the proxy can be also easily removed from its position on the phone and can also be used further away from the user's head, as described in solution 1 of the patent summary. Preferably, for recharging, the proxy can either be removed from its position on the phone and moved to the appropriate socket, or for example an auxiliary wire can be used that is removed when not recharging.

While the invention has been described with respect to a limited number of embodiments, it will be appreciated that many variations, modifications, expansions and other applications of the invention may be made which are included within the scope of the present invention, as would be obvious to those skilled in the art.

I claim:

1. A system for reducing the level of microwave radiation that the user's brain is exposed to while using cellular phones, comprising:
A cellular phone;
A proxy device which can communicate on one hand with the cellular phone at a short range without a metallic wire between them and on the other hand can communicate with the cellular company's cells at least in one operation mode;
And wherein at least one of:
a. The proxy does not significantly increase the weight and size that the user has to carry.
b. The proxy and the phone are recharged together.
c. The proxy and the phone are perceived like a single device with two integral parts.
d. The proxy and the phone at least one of behave like and look like a single device at least part of the time.
e. The proxy's main or only function is to reduce the radiation that the user is exposed to near his brain.

2. The system of claim 1, wherein said cellular phone works with its normal antenna and is used directly by the user and said proxy device works at a small distance from the user by imitating on one hand the cellular company's cell, thus making the phone behave as if it is talking with a very close cell and thus automatically adjust its radiation level to minimum, and on the other hand said proxy device communicates normally with the cellular company's cells.

3. The system of claim 2, wherein said proxy device uses two cellular antennas, one to communicate with said cellular phone and one to communicate with the cellular company's cells.

4. The system of claim 2, wherein said proxy device uses one cellular antenna with fast timeslicing to communicate intermittently both with said cellular phone and with the cellular company's cells.

5. The system of claim 2, wherein said proxy device has one cellular antenna and uses different frequencies to communicate at the same time both with said cellular phone and with the cellular company's cells.

6. The system of claim 1, wherein said cellular phone has instead of its normal cellular antenna a short range low energy wireless communication device for communicating with said proxy device and is used directly by the user and said proxy device works at a small distance from the user by using a second short range low energy wireless communication device on one hand, and on the other hand said proxy device communicates through a normal cellphone antenna with the cellular company's cells.

7. The system of claim 1, wherein said cellular phone has, in addition to its normal cellular antenna, a short range low energy wireless communication device added to it for communicating with said proxy device and is used directly by the user and said proxy device works at a small distance from the user by using a second short range low energy wireless communication device on one hand, and on the other hand said proxy device communicates through a normal cellphone antenna with the cellular company's cells.

8. The system of claim 7, wherein additionally when said cellular phone is temporarily unable to communicate with said proxy device, it can switch to normal operation (using its cellular antenna) and can alert the user that he is exposed to the normal cellular microwave radiation.

9. The system of claim 7 wherein said proxy device has also a microphone and an earphone and is at least in one operation mode in the shape of a headset, and said cellular phone and said proxy device can both operate in two modes and detect the correct mode and communicate their current mode to each other through the short range low energy wireless communication that exists between them:
Mode 1, in which both said cellular phone and said proxy device function as described in the device of claim 7;
Mode 2, in which said proxy device is being used as a headset and thus deactivates its cellular antenna and activates its earphone and microphone, and said cellular phone deactivates its built-in speaker and microphone and reactivates its cellular antenna and uses it to communicate with the cellular company's cells and regards the proxy device as a headset.

10. The system of claim 8 wherein said proxy device has also a microphone and an earphone and is at least in one operation mode in the shape of a headset, and said cellular phone and said proxy device can both operate in two modes and detect the correct mode and communicate their current mode to each other through the short range low energy wireless communication that exists between them:
Mode 1, in which both said cellular phone and said proxy device function as described in the device of claim 8;
Mode 2, in which said proxy device is being used as a headset and thus deactivates its cellular antenna and activates its earphone and microphone, and said cellular phone deactivates its built-in speaker and microphone and reactivates its cellular antenna and uses it to communicate with the cellular company's cells and regards the proxy device as a headset; and when said proxy is temporarily unable to communicate with said cellular phone, it can switch to communicating directly with the cellular company's cells (using its cellular antenna) and can alert the user that he is exposed to the normal cellular microwave radiation.

11. The system of claim 1, wherein said cellular phone has instead of its normal cellular antenna optic fiber technology for communicating with said proxy device and is used directly by the user and said proxy device works at a small distance from the user by fiber optic technology on one hand, and on the other hand said proxy device communicates through a normal cellphone antenna with the cellular company's cells.

12. The system of claim 1, wherein said cellular phone has, in addition to its normal cellular antenna, optic fiber technology for communicating with said proxy device and is used directly by the user and said proxy device works at a small distance from the user by fiber optic technology on one hand, and on the other hand said proxy device communicates through a normal cellphone antenna with the cellular company's cells.

13. The system of claim 12, wherein additionally when said cellular phone is temporarily unable to communicate with said proxy device, it can switch to normal operation (using its cellular antenna) and can alert the user that he is exposed to the normal cellular microwave radiation.

14. The system of claim 12 wherein said proxy device has also a microphone and an earphone and is at least in one operation mode in the shape of a headset, and said cellular phone and said proxy device can both operate in two modes and detect the correct mode and communicate their current mode to each other through the fiber optic communication that exists between them:
Mode 1, in which both said cellular phone and said proxy device function as described in the device of claim 12;
Mode 2, in which said proxy device is being used as a headset and thus deactivates its cellular antenna and activates its earphone and microphone, and said cellular phone deactivates its built-in speaker and microphone and reactivates its cellular antenna and uses it to communicate with the cellular company's cells and regards the proxy device as a headset.

15. The system of claim 13 wherein said proxy device has also a microphone and an earphone and is at least in one operation mode in the shape of a headset, and said cellular phone and said proxy device can both operate in two modes and detect the correct mode and communicate their current mode to each other through the fiber optic communication that exists between them:
Mode 1, in which both said cellular phone and said proxy device function as described in the device of claim 13;
Mode 2, in which said proxy device is being used as a headset and thus deactivates its cellular antenna and activates its earphone and microphone, and said cellular phone deactivates its built-in speaker and microphone and reactivates its cellular antenna and uses it to communicate with the cellular company's cells and regards the proxy device as a headset; and when said proxy is temporarily unable to communicate with said cellular phone, it can switch to communicating directly with the cellular company's cells (using its cellular antenna) and can alert the user that he is exposed to the normal cellular microwave radiation.

16. The system of claim 6 wherein the proxy device is physically coupled to the cellular phone, and extends the position of the cellular antenna as far away from the brain as conveniently possible.

17. The system of claim 16, wherein at least one of the following features exist:
a. The proxy can be easily rotated by the user at various angles.
b. The user can easily alter the length of the proxy device.
c. The proxy can be easily removed from the phone, so that the proxy can also be used further away from the user's head.

18. The system of claim 11, wherein said proxy device is physically coupled to the cellular phone, and extends the position of the cellular antenna as far away from the brain as conveniently possible.

19. The system of claim 18, wherein at least one of the following features exist:
a. The proxy can be easily rotated by the user at various angles.
b. The user can easily alter the length of the proxy device.
c. The proxy can be easily removed from the phone and the optic fiber can be folded and released, so that the proxy can also be used further away from the user's head.

20. A method for reducing the level of microwave radiation that the user's brain is exposed to while using cellular phones, comprising:
Using a cellular phone;
Using a proxy device which can communicate on one hand with the cellular phone at a short range without a metallic wire between them and on the other hand can communicate with the cellular company's cells at least in one operation mode;
And wherein at least one of:
a. The proxy does not significantly increase the weight and size that the user has to carry.
b. The proxy and the phone are recharged together.
c. The proxy and the phone are perceived like a single device with two integral parts.
d. The proxy and the phone at least one of behave like and look like a single device at least part of the time.
e. The proxy's main or only function is to reduce the radiation that the user is exposed to near his brain.

21. The method of claim 20, wherein said cellular phone works with its normal antenna and is used directly by the user and said proxy device works at a small distance from the user by imitating on one hand the cellular company's cell, thus making the phone behave as if it is talking with a very close cell and thus automatically adjust its radiation level to minimum, and on the other hand said proxy device communicates normally with the cellular company's cells.

22. The method of claim 21, wherein said proxy device uses two cellular antennas, one to communicate with said cellular phone and one to communicate with the cellular company's cells.

23. The method of claim 21, wherein said proxy device uses one cellular antenna with fast timeslicing to communicate intermittently both with said cellular phone and with the cellular company's cells.

24. The method of claim 21, wherein said proxy device has one cellular antenna and uses different frequencies to communicate at the same time both with said cellular phone and with the cellular company's cells.

25. The method of claim 20, wherein said cellular phone has instead of its normal cellular antenna a short range low energy wireless communication device for communicating with said proxy device and is used directly by the user and said proxy device works at a small distance from the user by using a second short range low energy wireless communication device on one hand, and on the other hand said proxy device communicates through a normal cellphone antenna with the cellular company's cells.

26. The method of claim 20, wherein said cellular phone has, in addition to its normal cellular antenna, a short range low energy wireless communication device added to it for communicating with said proxy device and is used directly by the user and said proxy device works at a small distance from the user by using a second short range low energy wireless communication device on one hand, and on the other hand said proxy device communicates through a normal cellphone antenna with the cellular company's cells.

27. The method of claim 26, wherein additionally when said cellular phone is temporarily unable to communicate with said proxy device, it can switch to normal operation (using its cellular antenna) and can alert the user that he is exposed to the normal cellular microwave radiation.

28. The method of claim 26 wherein said proxy device has also a microphone and an earphone and is at least in one operation mode in the shape of a headset, and said cellular phone and said proxy device can both operate in two modes and detect the correct mode and communicate their current mode to each other through the short range low energy wireless communication that exists between them:
Mode 1, in which both said cellular phone and said proxy device function as described in the device of claim 26;
Mode 2, in which said proxy device is being used as a headset and thus deactivates its cellular antenna and activates its earphone and microphone, and said cellular phone deactivates its built-in speaker and microphone and reactivates its cellular antenna and uses it to communicate with the cellular company's cells and regards the proxy device as a headset.

29. The method of claim 27 wherein said proxy device has also a microphone and an earphone and is at least in one operation mode in the shape of a headset, and said cellular phone and said proxy device can both operate in two modes and detect the correct mode and communicate their current mode to each other through the short range low energy wireless communication that exists between them:
Mode 1, in which both said cellular phone and said proxy device function as described in the device of claim 27;
Mode 2, in which said proxy device is being used as a headset and thus deactivates its cellular antenna and activates its earphone and microphone, and said cellular phone deactivates its built-in speaker and microphone and reactivates its cellular antenna and uses it to communicate with the cellular company's cells and regards the proxy device as a headset; and when said proxy is temporarily unable to communicate with said cellular phone, it can switch to communicating directly with the cellular company's cells (using its cellular antenna) and can alert the user that he is exposed to the normal cellular microwave radiation.

30. The method of claim 28, wherein said cellular phone has instead of its normal cellular antenna optic fiber technology for communicating with said proxy device and is used directly by the user and said proxy device works at a small distance from the user by fiber optic technology on one hand, and on the other hand said proxy device communicates through a normal cellphone antenna with the cellular company's cells.

31. The method of claim 28, wherein said cellular phone has, in addition to its normal cellular antenna, optic fiber technology for communicating with said proxy device and is used directly by the user and said proxy device works at a small distance from the user by fiber optic technology on one hand, and on the other hand said proxy device communicates through a normal cellphone antenna with the cellular company's cells.

32. The system of claim 6 wherein said cellular phone is light enough to be used also as a headset and can be conveniently hung on at least part of the user's head as a hands-free headset.

33. The system of claim 32 wherein said proxy also has a screen and keyboard so that it can be held in the hand when accessing the Internet if the user is using said phone as a headset.

34. The system of claim 1 wherein the phone fits over the proxy like a phone cover, like a two-part phone, so when the user opens the phone to initiate or answer a call it feels like picking up the phone's cover.

35. The system of claim 6 wherein the phone fits over the proxy like a phone cover, like a two-part phone, so when the user opens the phone to initiate or answer a call it feels like picking up the phone's cover.

36. The system of claim 1 wherein the phone can communicate both with the proxy and with at least one of a normal headset, a wireless headset, and other types of headsets.

37. The system of claim 6 wherein the phone can communicate both with the proxy and with at least one of a normal headset, a wireless headset, and other types of headsets.

38. The system of claim 1 wherein at least one of the phone and the proxy are using at least one of PWM and/or a piezoelectric speaker and/or a small air tube that goes into the ear in order to save energy and allow longer times till recharge of the battery is needed.

39. The system of claim 1 wherein at least one of the phone and the proxy contain also at least one of volume control and pitch control.

40. The system of claim 9 wherein the proxy is composed of two easily detouchable parts, so that one part contains the heavier battery needed for cellular communications and the cellular antenna and its circuitry, and the other part contains at least the earphone and microphone and a lighter battery, and when the parts are physically coupled they are electrically connected, and when the user wants to use the proxy as headset he can remove and use just the needed part.

41. A cellular phone with at least one of wireless or optic fiber headset wherein the headset fits over the phone like a two-part phone, so that when the user picks up the cover he is actually picking up the headset.

42. The system of claim 1 wherein at least one of the phone and the proxy can be used to signal to the other device to emit a sound so that the user can find it if he misplaced it and has in his hand just one of the two devices.

43. The system of claim 2 wherein the cellular phone is designed so that it can reduce the energy level of the normal antenna to the very low levels needed to communicate for example with a proxy device that is just a few meters or less away.

44. The system of claim 2 wherein the at least one the phone and the proxy can use at least one of automatic frequency hoping and encryption in order to help privacy and/or avoid disturbances between near devices.

45. The system of claim 2 wherein the phone is able to indicate to the user if the proxy device cannot be reached or is malfunctioning, so that the user knows that he might now be exposed to the normal cellular radiation.

46. A cellular phone which communicates with at least one of a wireless headset or with a proxy such as the one defined in claim 1 wherein free air optical communication is used between the phone and the proxy, and automatic frequency selection is done by at least one of: Using LED matrices (for example in a chip) with LEDs of different frequencies each, so that the appropriate LEDs can be easily chosen; Using a set of differently colored filters in front of at least one LED that covers a certain range of frequencies, so that different filters can be automatically chosen and moved in order to change the frequency; Using various power combinations to create the desired combined frequency, similar to a color pixel; Using tunable diodes; and Using different broadcast characteristics.

47. The system of claim 46 wherein said different broadcast characteristics are at least one of: using fatter or thinner bits and using different bit placement within each frame of communication.

48. The system of claim 1 wherein the phone and the proxy are recharged together through a parallel connection, or serially—one through the other.

49. A cellular phone with an electromagnetic wireless headset wherein the headset and phone are recharged together through a parallel connection, or serially—one through the other.

50. The system of claim 36 wherein at least one of the phone and a headset can communicate directly with the proxy.

51. The system of claim 1 wherein the phone and the proxy at least one of behave and look like a single device when being recharged and/or when not in use, and detouch into two devices whenever the user answers or initiates a call.

52. The system of claim 7 wherein the cellular phone has a lighter battery than an equivalent normal cellular phone would have since it has to use this antenna only in emergencies or other rare occasions that make it impossible to connect to the cells through the proxy.

53. The system of claim 1 wherein the phone can have a lighter battery by being able to be recharged automatically when connected to the proxy even without the normal recharger.

54. The system of claim 9 wherein at least one of the phone and the proxy have a lighter battery than a usual cellular phone and can automatically exchange energy between them when connected to each other even without the normal recharger.

55. The system of claim 41 wherein the headset can be recharged automatically from the phone by being connected to it even without the normal recharger, thus allowing the use of a lighter battery at the headset.

56. The system of claim 49 wherein the headset can be recharged automatically from the phone by being connected to it even without the normal recharger, thus allowing the use of a lighter battery at the headset.
